(19) United States
(12) Patent Application Publication
(10) Pub. No.: US 2016/0370775 A1
(43) Pub. Date: Dec. 22, 2016

(54) METHODS AND SYSTEMS FOR REMOTE MULTI-TENANT FACILITY MANAGEMENT

(71) Applicants: Dan Daugherty, Denver, CO (US); Eric Spery, Denver, CO (US)

(72) Inventors: Dan Daugherty, Denver, CO (US); Eric Spery, Denver, CO (US)

(21) Appl. No.: 14/744,735

(22) Filed: Jun. 19, 2015

(51) Int. Cl. G05B 15/02; H04L 12/28

(52) U.S. Cl. CPC G05B 15/02; H04L 12/2816

(57) ABSTRACT

A method and system for remote multi-tenant facility management are presented. The invention comprises a client-side user interface communicatively coupled to a system management unit. The system management unit includes multiple standalone management components that monitor and execute system inspection, rules processing, data logging, and other asynchronous processing. The system includes interfaces for users to create automations that serve as a proxy for controlling remote devices connected to the system. The system management unit includes multiple system processes running autonomously. The system management unit is further communicatively coupled to one or more remote devices through one or more Device Access Providers in the multi-tenant facility for monitoring and/or control of the remote devices.

### BACKGROUND OF THE INVENTION

Field of the Invention

Embodiments of the invention relates to the field of automation. More specifically, the invention relates to method and systems for remote multi-tenant facility management.

Description of the Related Art

Multi-tenant facilities such as office buildings and apartment complexes include controllable devices in tenant units and in common areas. Controllable devices include locks, switches, sensors, speakers, thermostats, etc. Some of these devices are controlled via hubs made by third party companies such as Icontrol, Mios, and Smart Things. Some devices are standalone devices with their own built-in hubs (or API) such as Nest Thermostats, Honeywell Wi-Fi thermostats, and Lockitron Bolt.

Devices such as Nest thermostats and Honeywell Wi-Fi thermostats communicate through their API. In the near future, it is expected that there would be other devices where the API lives on the actual device eliminating the need for an API layer controlled by a third Party.

For example, August lock has a lock that can be controlled out of the box via Bluetooth. However, there is a secondary hub device that provides Wi-Fi access to the August lock device. The problem is that when power goes out in such a system, access to the device through Wi-Fi is lost, though it is still accessible via Bluetooth.

However, as these devices and their proprietary APIs proliferate in a multi-tenant facility, there is a need for central and remote management and automation of control of these devices to improve quality of life.

### BRIEF SUMMARY OF THE INVENTION

One or more embodiments of the invention are directed to a method and systems for remote multi-tenant facility management. Systems and methods of the present invention facilitate automation and control of devices within a network in a multi-tenant facility with one or more tenant units in the multi-tenant facility having one or more remote devices. For instance an embodiment may comprise gateways/hubs placed within a rental residence to facilitate communication with automated devices present within the network. The system is configured to be hub and device agnostic because typical multi-tenant facilities, in embodiments of the present invention, are made up of one or more third party gateways placed within one or more tenant units to facilitate communication with automated devices present within the network.

In one or more embodiments of the present invention, each of the remote devices, e.g. switches, locks, thermostats, smoke detectors, moisture detectors, carbon monoxide detectors, speakers, etc. may communicate with other systems of the present invention via Device Access Providers (DAPs). Communication may be via Wi-Fi, Bluetooth, or any other suitable wireless communication system.

In one or more embodiments, each Device Access Provider (DAP) acts as a Hub/Gateway allowing communication with and control of one or more remote devices in a property. Each multi-tenant facility may comprise multiple Device Access Providers that are managed by systems and methods of the present invention, with one or more remote devices managed by each DAP.

In one or more embodiments, a remote device and a DAP may be an integrated unit. For instance, where the Application Program Interface (API) lives on the device, the device may be operated as a DAP.

One or more embodiments of the present invention further comprise a system management unit. The system management unit comprises standalone management components that monitor and execute system inspection, rules processing, data logging, and other asynchronous processing. The system includes interfaces for users to create automations (executed by system processes) that serve as a proxy for controlling devices; these automations can be shared with other users in the system and external to the system. The system management unit may comprise multiple system processes running autonomously.

In one or more embodiments, the system management may communicate with the DAPs through one or more wireless protocols, e.g. Bluetooth, Wi-Fi, 3G, LTE, etc. The system management unit controls the actions of a device and monitors the state of the device through the DAP connected to the device.

In one or more embodiment of the present invention, the systems and methods further comprises a client-side user interface. The client-side user interface may comprise a mobile application on a mobile client, e.g. an iOS or Android device such as smartphones, tablets, smartwatches, etc. using a Mobile App. The client-side user interface may also comprise a web client on any smart device or computer system.

One or more embodiments of the invention may be configured for different classes of users. For instance, the system may include a Resident User; Property Owner/Manager User; and System Operator.

A Resident User may be classified as one or more residents within a tenant unit. Each Resident User may have access to devices within their tenant unit using a web client or a mobile application, e.g. iOS or Android applications. Each tenant unit can have multiple resident users with unique logins and their own automation sets.

A Property Owner/Manager may be classified as management of the multi-tenant unit. A Property Owner/Manager may access all aggregated devices for their communities using a web-based management platform or a mobile management application, e.g. iOS or Android. Each property can have multiple managers and owners with unique logins and distinct automation sets.

A System Administrator is a user with access to manage all devices, units, communities and system data using a web-based application.

In one or more embodiments, the system management unit includes a rules engine that matches patterns in device event states to create automations. These states can be coupled with other external conditions, e.g. weather, to create a desired outcome. For instance, the result may be matched to a desired or defined action by acting on system controlled resources, e.g. devices, or by creating notifications. Rules can be defined by residents, property owner /managers and system administrators.

For example, a resident user may define a rule wherein the system obtains information about the user through the mobile app, e.g. his/her location, traffic/congestion on their route home and environmental conditions. Using these and other information, the system may know when he/she leaves work and how long it will take to get home. Thus, the rule may comprise an action of turning the temperature up/down at the right time to get the tenant unit to the preferred temperature by the time the renter/owner gets home.

### BRIEF DESCRIPTION OF THE DRAWINGS

The above and other aspects, features and advantages of the invention will be more apparent from the following more particular description thereof, presented in conjunction with the following drawings wherein:

FIG. 1 is an architectural representation of the logical interconnection of components, hardware and software, for management of a multi-tenant facility in accordance with one or more embodiments of the present invention.

FIG. 2 is an architectural representation of the system management unit showing a breakdown of the Autonomous Processing Unit and the logical connections for of a multi-tenant facility in accordance with one or more embodiments of the present invention.

FIG. 3 illustrates a general-purpose computer and peripherals that when programmed as described herein may operate as a specially programmed computer capable of implementing one or more methods, apparatus and/or systems of the present invention.

### DETAILED DESCRIPTION

The present invention comprising methods and systems for remote multi-tenant facility management will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

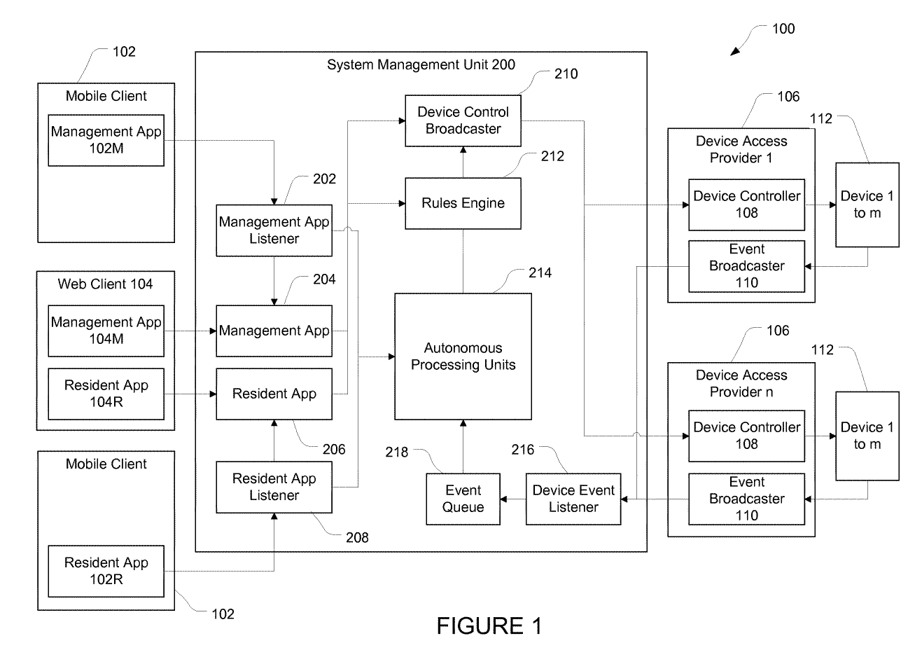

One or more embodiments of the present invention will now be described with references to FIGS. 1-3.

Systems and methods of the present invention facilitate automation and control of devices within a network in a multi-tenant facility. FIG. 1 is an architectural representation of the logical interconnection of components, hardware and software, for management of a multi-tenant facility in accordance with one or more embodiments of the present invention.

As illustrated, one or more embodiment of the system 100 of the present invention comprises a client-side user interface, e.g. Mobile Client 102 and Web Client 104. The Mobile Client 102 may comprise one or more mobile applications, e.g. management App 102M and Resident App 102R. The mobile client 102 may be an iOS device, an Android device, or any smart device such as smartphones, tablets, smartwatches, etc. capable of communicating wirelessly through a computer network.

In one or more embodiments, the client-side user interface may also comprise a web client 104 on any smart device or computer system. Web client 104 may comprise one or more mobile applications, e.g. Management App 104M and Resident App 104R.

In one or more embodiments of the invention, the client-side interface may be configured for different classes of users. For instance, the system may include a Resident User; Property Owner/Manager User; and System Operator.

A Resident User may be classified as one or more residents within a tenant unit. Each Resident User may have access to devices within their tenant unit using a web client or a mobile application, e.g. iOS or Android applications. Each tenant unit can have multiple resident users with unique logins and their own automation sets.

A Property Owner/Manager may be classified as management of the multi-tenant unit. A Property Owner/Manager may access all aggregated devices for their communities using a web-based management platform or a mobile management application, e.g. iOS or Android. Each property can have multiple managers and owners with unique logins and distinct automation sets.

A System Operator is a user with access to manage all devices, units, communities and system data using a web-based application.

Resident Application

One or more embodiments of the present invention comprise Resident App 102R on a mobile client 102; Resident App 104R on Web Client 104; and Resident App 206 in the System Management Unit 200. In one or more embodiments, Resident App 104R in Web Client 104 is a web interface to Resident App 206.

In one or more embodiments, Resident App 102R communicates by passing messages to a client application listener, e.g. Resident App Listener 208. The messages may be exchanged with the Resident App Listener 208 using a standard data interchange language, e.g. JSON (Java Script Object Notation) implemented as RESTful web services using Java 2 Platform, Enterprise Edition (J2EE) technologies.

In one or more embodiments, Resident App Listener 208 converts the messages to and from the Resident App 102R to match the message format in Resident App 206 web application, which may be implemented using various client side markup languages, e.g. HTML, CSS, etc., and various JavaScript frameworks.

Resident App Listener 208 is the set of web services that allow communications between system management unit functionality and mobile applications, e.g. Resident App 102R. In one or more embodiments, Resident App Listener 208 may be configured to receive inbound commands from third party systems interfacing with the system of the present invention, e.g. application services provided by Yardi and RealPage.

In one or more embodiments, Resident App user interface, e.g. 102R or 104R, provides the user the capability to inspect the device state. For example, the User Interface allows a resident to examine the state of all devices under their control. They can drill down to an individual device level allowing the user to see multiple properties of the device. Thus, for example, a user is driving to work and can't remember if they locked the door to their unit. The user can pull over and access the system using the Resident App 102R in his/her mobile device, and inspect to see if they did leave the door unlocked.

In one or more embodiments, Resident App user interface, e.g. 102R or 104R, provides the user the capability to control one or more devices. For example, the User Interface allows a user to change the state of all manipulable devices under their control. They can drill down to an individual device level allowing the user to control multiple properties of the device. Thus, in the same example above, if the user determines that the door is unlocked, they can issue user-driven/custom commands to lock the door.

In one or more embodiments, Resident App user interface, e.g. 102R or 104R, provides the user the capability to create Rules. Rules are generally automations that may cause the change of state of one or more devices based on one or more events or combination of events, e.g. device state, sensor readings in the tenant unit, weather conditions, resident state, etc. Rules may also provide various types of notifications based on one or more events. For example, if a moisture detector under a hot water heater detects moisture, the system can send an automated voice call, SMS, and/or Email alerting residents and/or managers to the condition. Additionally, the system may notify third party web services depending on the condition/event so that the third parties can act within their own processes. For instance, the system may notify the third party web service such that the third party's processes initiates its own maintenance sequence, e.g. sending a maintenance manager out in response to the event.

The resident app 102R may provide a visual interface that allows the creation of system executable scripts. These scripts, when executed for the user by the system, can asynchronously control multiple remote devices associated with the user on the user's behalf.

One or more embodiments of the system of the present invention may be configured to collect real-time information about a user through the Resident App 102R, e.g. his/her location, traffic/congestion on their route home, environmental conditions, etc. The system may be configured to use the information to supplement device state information for automation. For example, based on his/her location, traffic/congestion on their route home, and environmental conditions the system may determine when the user leaves work and how long it will take to get home. Thus, a cost saving automation may comprise an action of turning the temperature up/down at the right time to get the tenant unit to the preferred temperature by the time the resident gets home.

Management Applications

One or more embodiments of the present invention comprise Management App 102M on a mobile client 102; Management App 104M on Web Client 104; and Management App 204 in the System Management Unit 200. In one or more embodiments, Management App 104M in Web Client 104 is a web interface to Management App 204.

In one or more embodiments, Management App 102M communicates by passing messages to a client application listener, e.g. Management App Listener 202. The messages may be exchanged with the Management App Listener 202 using a standard data interchange language, e.g. JSON (Java Script Object Notation) implemented as RESTful Web services using Java 2 Platform, Enterprise Edition (J2EE) technologies.

In one or more embodiments, Management App Listener 202 converts the messages to and from the Management App 102M to match the message format in Management App 202 web application, which may be implemented using various client side markup languages, e.g. HTML, CSS, etc., and various JavaScript frameworks.

Management App Listener 202 is the set of web services that allow communications between the system management unit functionality and mobile applications, e.g. Management App 102M. In one or more embodiments, Management App Listener 202 may be configured to receive inbound commands from third party systems interfacing with the system of the present invention, e.g. application services provided by Yardi and RealPage.

In one or more embodiments, Management App user interface, e.g. 102M or 104M, provides the user the capability to control one or more devices in a multi-tenant facility. Management App 204 generally has the capability to control one to many back-end devices. For instance, management may configure the system such that common area devices are shared with all residents or just a subset of residents allowing them access to devices and automated functionality in the common areas of the multi-tenant facility.

In one or more embodiments, Management App user interface, e.g. 102M or 104M, provides the user the capability to manage residents, devices within units and communities in a multi-tenant facility. For example, Management App 204 may be used to manage accounts for all users accessible by a specific management account. In one or more embodiments, Management App 204 provides the capability to create, delete and edit resident accounts, unit accounts, and community accounts.

In one or more embodiments, Management App user interface, e.g. 102M or 104M, provides the user the capability to inspect state of devices within the system. For example, the User Interface provides a management user the ability to examine the state of all devices registered to the system. They can drill down to an individual device level allowing the management user to see multiple properties of a device.

In one or more embodiments, Management App user interface, e.g. 102R or 104R, provides the management user the capability to control one or more devices in the system. For example, the User Interface may be configured to allow a management user to change the state of all manipulable devices in the system. They can drill down to an individual device level allowing the management user to control multiple properties of the device. An exemplary management user control may be as follows: A moisture detector in the system detects a water leak in a resident's bathroom. The front office dispatches a maintenance worker to investigate. The maintenance worker shows up at the front door, using the management application maintenance worker may unlock the front door and enter the residence.

In one or more embodiments, Management App user interface, e.g. 102M or 104M, provides the user the capability to create and modify bulk rules. That is, rules to allow the system to asynchronously control devices, e.g. thermostats. Bulk rules creation eases the burden of creating automations for one to many units at a time by providing templates to create bulk automations. Users can create/modify their own templates.

For instance, assuming a property manager has five communities that have three managed common areas each. This is a total of fifteen managed common units. Also, assuming the business hours is from 7 am-7 pm and management wants the temperature set at 72 degrees during business hours, but 62 degrees outside of business hours. Management can create individual automations, i.e. rules, for all fifteen of these offices, or they can use the bulk rules capability to create a single automation that will be applied to each unit.

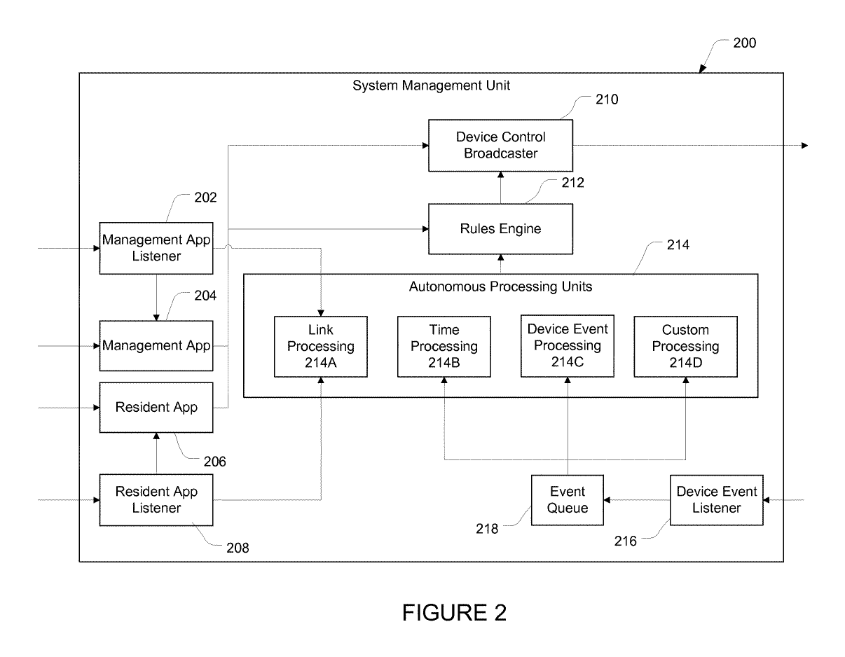

FIG. 2 is an architectural representation of the system management unit 200 showing a breakdown of the Autonomous Processing Unit 214 and the logical connections for of a multi-tenant facility in accordance with one or more embodiments of the present invention. As illustrated, the client app listener, e.g. Management App Listener 202 and Resident App Listener 208, are coupled to link processing unit 214A.

In one or more embodiments, the link processing unit is configured not to listen to internal processes or states in order to act. Thus, when the Client App Listener detects links, i.e. HTTP calls, in the Resident App 102R or Management App 102M, the links are executed immediately by devices (e.g. web servers, etc.) outside of system. These HTTP calls are handled immediately by that group of generic processes/web-services referred to herein as the Client App Listener, i.e. Management App Listener 202 and Resident App Listener 208.

As illustrated, one or more embodiment of the system 100 of the present invention further comprises Device Control and Broadcaster 210; Rules Engine 212; Autonomous Processing Units 214; Device Event Listener 216; and Event Queue 218 in the system management unit 200. System 100 further comprises one or more DAPs 106, e.g. Device Access Provider 1 to Device Access Provider n, where n is any number greater than or equal to 1. In a typical implementation, n is greater than 1 and may be much greater than 1.

Device Control Broadcaster

The Device Control Broadcaster 210 is the component responsible for communicating desired device changes to Device Access Providers 106. In one or more embodiments, Device Control Broadcaster 210 manages and is responsible for translating device commands into messages for broadcast to Device Controller 108 in Device Access Providers (DAP) 106 through their required communication types, e.g. RESTful web services, Firebase, Thrift, custom SDKs, proprietary Enterprise Service Bus, etc. In one or more embodiments, Device Control Broadcaster 210 is implemented as a Java/Groovy managed component. Those of skill in the arts would appreciate that the use of Java/Groovy is exemplary and that other object-oriented programming languages may be used for Device Control Broadcaster 210 without departing from the spirit of the present invention.

In one or more embodiments, Device Control Broadcaster 210 is coupled to Management App 204 and Resident App 206 for direct control of devices registered in the system, e.g. device 112 through Device Controller 108 of DAP 106.

In one or more embodiments, Device Control Broadcaster 210 is coupled to Rules Engine 212 for automated control of devices registered in the system, e.g. device 112 through Device Controller 108 of DAP 106.

Device Control Broadcaster 210 abstractly knows what types of DAPs it is coupled to, the API for the DAP, and handles the translations appropriately.

Device Event Listener

The Device Event Listener 216 is the component responsible for receiving device event states through Device Access Providers 106. In one or more embodiments, Device Event Listener 216 is responsible for translating device states from Event Broadcaster 110 into messages to be queued in Event Queue 218. Event Broadcaster 110 in Device Access Providers (DAP) 106 sends states of device 112 to Device Event Listener 216 using its communication type, e.g. RESTful web services, Firebase, Thrift SDK, custom SDKs, proprietary Enterprise Service Bus, etc. In one or more embodiments, Device Event Listener 216 is implemented as a Java/Groovy managed component. Those of skill in the arts would appreciate that the use of Java/Groovy is exemplary and that other object-oriented programming languages may be used for Device Event Listener 216 without departing from the spirit of the present invention.

Rules Engine

One or more embodiments of the present invention comprise a Rules Engine 212. Rules Engine 212 comprises rules (or automations) that provide users the capability to automate system actions based on certain conditions/criteria. Thus, a rule in the rules engine 212 may be configured to trigger a specific set of actions when a specific condition occurs. For instance, a user may create a rule that when their front lock unlocks, they want the hall light to come on.

The rules engine may be applied to every system event through processing units, e.g. autonomous processing units 214, assigned to watch those specific events (e.g. device-based, time-based, etc.). For all events that occur, the rules engine discovers applicable rules and executes them.

In one or more embodiments, the rules engine provides the system the capability to match patterns in device event states to create automations. These states can be coupled with other external conditions, e.g. weather, to create a desired outcome. For instance, the result may be matched to a desired or defined action by acting on system controlled resources, e.g. devices, or by creating notifications. Rules can be defined by residents, property owner /managers and system administrators.

In one or more embodiments of the present invention, the rules engine 212 comprises time-based automations/rules. For instance, the system monitors when the defined time requirement is reached and executes the associated automation(s)/rule(s).

An example of a time-based automation/rule could be: At 7:15 pm turn on Christmas Tree Lights and front Hallway Light.

In one or more embodiments of the present invention, the rules engine 212 comprises link-based automations/rules. For example, by a user clicking a link in the client-side interface, e.g. Resident App 102R, the event is logged and then the desired automation is triggered. There are a number of different expiration schemes for links, e.g. use-based, time-based, condition-based and event-based.

In one or more embodiments of the present invention, the rules engine 212 comprises device-based automations. Device or event based automations/rules are those actions that are triggered by state changes in devices.

An example of an event based automation/rule could be: If Front Door Lock Unlocks, Turn On Front Hall Light.

In one or more embodiments of the present invention, the rules engine 212 comprises User-driven Automations. User-driven rules are “Run Now” automations/rules that allow the user to manually run automations without a condition being applied (i.e., no device event change or time requirement.) User-driven rules can be used to create an overall state for a user's residence. For example, a user may create a “Run Now” automation for “Shut Down House For Night”, which turns off all switches and locks all external locks in the house.

Autonomous Processing Units

In one or more embodiments, autonomous processing units 214 comprises one or more processing units, e.g. Link-based events processing, e.g. 214A; Time-based events processing, e.g. 214B; Device-based events processing, e.g. 214C; and User-driven/custom events processing, e.g. 214D. These processing units may be designed to sit and watch for one or more conditions in Event Queue 218, for example. For instance, a device's state has changed and it's been reported to the system via device event listener 216 and logged in event queue 218, e.g. a lock has been unlocked or a light has been turned out. Time-based processing unit 214B watches for changes in time. Both Custom Processing unit 214D and Link Processing unit 214A are initiated by a specific user action (e.g. a button was clicked or a link was clicked). In any case, these processors sit and watch for changing conditions. When a condition they're watching changes, they use the Rules Engine to determine if the change is actionable. If it is actionable, the action(s) registered to it are executed. If it's not, the condition is logged.

It should be noted that the autonomous processing units, e.g. 214A through 214D, may be implemented as virtual machines in a server computer, software objects, etc.

One or more embodiments of the present invention comprise a multi-tenant facility, with one or more tenant units in the multi-tenant facility having one or more remote devices. As illustrated, each remote device 112 is coupled to a Device Access Provider 106. Thus, each of the remote devices, e.g. 112, communicates with other systems of the present invention via Device Access Providers (DAPs), e.g. 106.

In one or more embodiments, each Device Access Provider 106 acts as a Hub/Gateway allowing communication with and control of one or more remote devices 112 in a property. Each multi-tenant facility may comprise multiple Device Access Providers that are managed by systems and methods of the present invention, with one or more remote devices managed by each DAP.

In one or more embodiments, a remote device and a DAP may be an integrated unit. For instance, where the Application Program Interface (API) lives on the device, the device may be operated as a DAP.

Device Access Providers (DAP)

In one or more embodiments of the present invention, Device Access Providers 106 provide the system with the capability to manage multiple devices in a unit. The system is abstracted in such a way that DAPs are treated as interfaces. Each DAP 106 may be easily added to the system and the specifics of working with each DAP is hidden from the rest of the system thus creating separation, i.e. each DAP has a unique identification in the system. This separation of concerns allows the system management unit to simply send commands to the interface, confident that the implemented interface will appropriately perform the request.

In one or more embodiments of the present invention, Device Access Providers 106 provide the system with the capability to control remote devices in a tenant unit. Each tenant unit can have multiple devices, each with a unique DAP. The system only needs to communicate with the DAP, treating it like yet another interface within the system. Other embodiments may also include configurations wherein a Dap controls multiple remote devices. In such configurations, each remote device within the DAP's control should have a unique identification within the DAP.

In one or more embodiments of the present invention, Device Access Providers 106 provide the system with the capability to receive state change information from remote devices 112. Thus, each DAP is able to push state change information into the system. This data can then be acted upon by the Rules Engine allowing automations and notifications. This inbound state change data also may also be used by data processes to suggest appropriate automations, e.g. for cost savings, etc.

Each DAP may interface with the system via third party dictated technologies such as RESTful web services, Fire base SDK, Thrift SDK, other custom SDKs, etc.

Remote Devices

Remote devices 112 are devices in a unit/common area in a multi-tenant facility that control access to the unit/common area, affect the state of the unit, provide information regarding the state of the unit, etc. Examples of remote devices include switches, locks, thermostats, smoke detectors, moisture detectors, carbon monoxide detectors, speakers, etc.

In one or more embodiments of the present invention, remote device 112 communicates to the system via Device Access Providers (DAPs) 106 using a wireless protocol, e.g. Z-wave, Zigbee, Insteon, and Wi-Fi, Bluetooth, etc.

In one or more embodiments, the system management may communicate with the DAPs through one or more wireless protocols, e.g. Bluetooth, Wi-Fi, 3G, etc. The system management unit controls the actions of a device and monitors the state of the device through the DAP connected to the device.

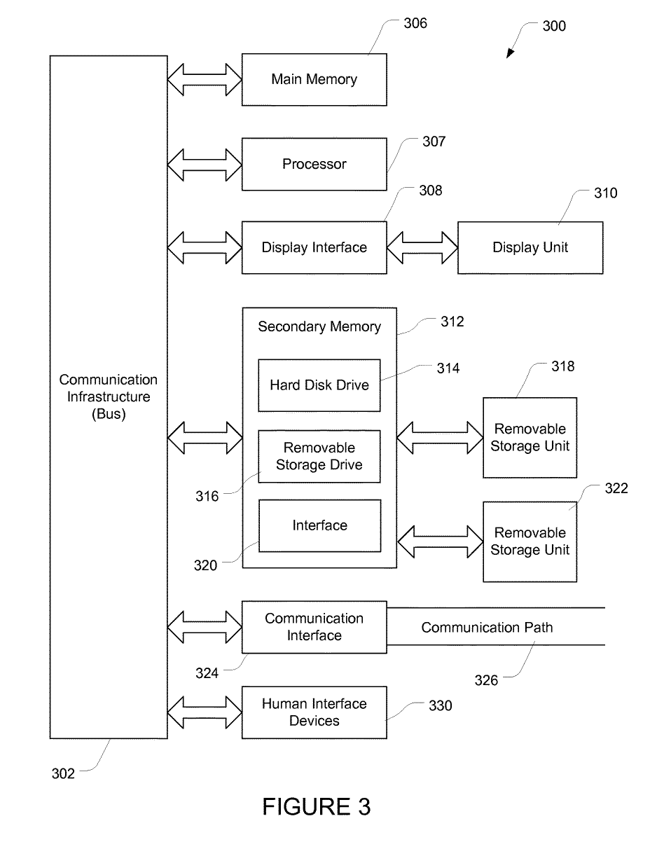

FIG. 3 diagrams a general-purpose computer (e.g. server) and peripherals, when programmed as described herein, may operate as a specially programmed computer capable of implementing one or more methods, apparatus and/or systems of the solution described in this disclosure. Specifically, the system management unit 200 may be implemented as computer system 300. Processor 307 may be coupled to bi-directional communication infrastructure 302 such as communication infrastructure system bus 302. Communication infrastructure 302 may generally be a system bus that provides an interface to the other components in the general-purpose computer system such as processor 307, main memory 306, display interface 308, secondary memory 312 and/or communication interface 324.

Main memory 306 may provide a computer readable medium for accessing and executed stored data and applications. Display interface 308 may communicate with display unit 310 that may be utilized to display outputs to the user of the specially-programmed computer system. Display unit 310 may comprise one or more monitors that may visually depict aspects of the computer program to the user. Main memory 306 and display interface 308 may be coupled to communication infrastructure 302, which may serve as the interface point to secondary memory 312 and communication interface 324. Secondary memory 312 may provide additional memory resources beyond main memory 306, and may generally function as a storage location for computer programs to be executed by processor 307. Either fixed or removable computer-readable media may serve as Secondary memory 312. Secondary memory 312 may comprise, for example, hard disk 334 and removable storage drive 316 that may have an associated removable storage unit 318. There may be multiple sources of secondary memory 312 and systems implementing the solutions described in this disclosure may be configured as needed to support the data storage requirements of the user and the methods described herein. Secondary memory 312 may also comprise interface 320 that serves as an interface point to additional storage such as removable storage unit 322. Numerous types of data storage devices may serve as repositories for data utilized by the specially programmed computer system. For example, magnetic, optical or magnetic-optical storage systems, or any other available mass storage technology that provides a repository for digital information may be used.

Communication interface 324 may be coupled to communication infrastructure 302 and may serve as a conduit for data destined for or received from communication path 326. A network interface card (NIC) is an example of the type of device that once coupled to communication infrastructure 302 may provide a mechanism for transporting data to communication path 326. Computer networks such Local Area Networks (LAN), Wide Area Networks (WAN), Wireless networks, optical networks, distributed networks, the Internet or any combination thereof are some examples of the type of communication paths that may be utilized by the specially program computer system. Communication path 326 may comprise any type of telecommunication network or interconnection fabric that can transport data to and from communication interface 324.

To facilitate user interaction with the specially programmed computer system, one or more human interface devices (HID) 330 may be provided. Some examples of HIDs that enable users to input commands or data to the specially programmed computer may comprise a keyboard, mouse, touch screen devices, microphones or other audio interface devices, motion sensors or the like, as well as any other device able to accept any kind of human input and in turn communicate that input to processor 307 to trigger one or more responses from the specially programmed computer are within the scope of the system disclosed herein.

While FIG. 3 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resource are made available on demand over the Internet or any other network. In one or more embodiments, the system may also encompass parallel systems, multi-processor systems, multi-core processors, and/or any combination thereof. Where a virtual machine, process, device or otherwise performs substantially similarly to that of a physical computer system, such a virtual platform will also fall within the scope of disclosure provided herein, notwithstanding the description herein of a physical system such as that in FIG. 3.

While the invention herein disclosed has been described by means of specific embodiments and applications thereof, numerous modifications and variations could be made thereto by those skilled in the art without departing from the scope of the invention set forth in the claims.

What is claimed is:

1. A system for remote multi-tenant facility management comprising:
one or more Device Access Providers (DAPs) coupled to one or more remote devices, wherein each of said Device Access Providers includes an Application Program Interface;
a system management unit communicatively coupled to said one or more DAPs through said Application Program Interface, wherein said system management unit comprises one or more autonomous components that monitor and execute system inspection, rules processing, data logging, and other asynchronous processing related to system management, wherein said rules are configured to automatically perform one or more of changing the state of at least one of said one or more remote devices and providing notification based on a device state event; and
a client-side user interface communicatively coupled to said system management unit, wherein said client-side interface comprises a resident application and a management application, wherein said resident application provides access for control of a subset of said one or more remote devices associated a user and said management application provides access for control of said one or more remote devices in a multi-tenant facility.

2. The system of claim 1, wherein said client-side user interface is a mobile client and said mobile client communicates with a client app listener component in said system management unit using JSON (Java Script Object Notation) messages implemented as RESTful web services.

3. The system of claim 1, wherein said client-side user interface is a web client.

4. The system of claim 1, wherein each of the one or more Device Access Providers comprises an event broadcaster for communicating device event states to a device event listener component in said system management unit.

5. The system of claim 1, wherein one or more of said device event states triggers automation and control of at least one of said one or more remote devices.

6. The system of claim 1, wherein each of the one or more Device Access Providers comprises a device controller for receiving device event state commands from a device control broadcaster component in said system management unit.

7. The system of claim 1, wherein said one or more autonomous components of said system management unit comprises a device control broadcaster for controlling the state of a device, a rules engine for generating device state automations using one or more asynchronous processing units, and a device event listener receiving the state of the device.

8. The system of claim 1, wherein said remote device includes one or more of locks, sensors, speakers, thermostats, smoke detectors, moisture detectors, and carbon monoxide detectors.

9. The system of claim 1, wherein said communicatively coupled is via wireless communication.

10. The system of claim 9, wherein said wireless communication is Wi-Fi.

11. A method for remote multi-tenant facility management comprising:
coupling one or more Device Access Providers (DAPs) to one or more remote devices in a multi-tenant facility, wherein each of said Device Access Providers includes an Application Program Interface;
communicatively coupling a system management unit to said one or more DAPs through said Application Program Interface, wherein said system management unit comprises one or more autonomous components that monitor and execute system inspection, rules processing, data logging, and other asynchronous processing related to system management; and
providing a client-side user interface for communicatively coupling to said system management unit, wherein said client-side interface comprises a resident application and a management application, wherein said resident application provides access for control of a subset of said one or more remote devices associated a user and said management application provides access for control of said one or more remote devices in a multi-tenant facility.

12. The method of claim 11, wherein said client-side user interface is a mobile client and said mobile client communicates with a client app listener component in said system management unit using JSON (Java Script Object Notation) messages implemented as RESTful web services.

13. The method of claim 11, wherein said client-side user interface is a web client.

14. The method of claim 11, wherein each of the one or more Device Access Providers comprises an event broadcaster for communicating device event states to a device event listener component in said system management unit.

15. The method of claim 11, wherein one or more of said device event states triggers automation and control of at least one of said one or more remote devices.

16. The method of claim 11, wherein each of the one or more Device Access Providers comprises a device controller for receiving device event state commands from a device control broadcaster component in said system management unit.

17. The method of claim 11, wherein said one or more autonomous components of said system management unit comprises a device control broadcaster for controlling the state of a device, a rules engine for generating device state automations using one or more asynchronous processing units, and a device event listener receiving the state of the device.

18. The method of claim 11, wherein said remote device includes one or more of locks, switches, sensors, speakers, thermostats, smoke detectors, moisture detectors, and carbon monoxide detectors.

19. The method of claim 11, wherein said communicatively coupled is via wireless communication.

20. A system for remote multi-tenant facility management comprising:
one or more Device Access Providers (DAPs) coupled to one or more remote devices, wherein each of said Device Access Providers includes an Application Program Interface;
a system management unit communicatively coupled to said one or more DAPs through said Application Program Interface, wherein said system management unit comprises one or more autonomous components that monitor and execute system inspection, rules processing, data logging, and other asynchronous processing related to system management; and
a client-side user interface communicatively coupled to said system management unit, wherein said client-side interface comprises a resident application and a management application, wherein said resident application provides access for control of a subset of said one or more remote devices associated a user and said management application provides access for control of said one or more remote devices in a multi-tenant facility.
